(19) United States
(12) Patent Application Publication
(10) Pub. No.: US 2010/0163354 A1
(43) Pub. Date: Jul. 1, 2010

(54) DAMPER

(76) Inventor: Sigmund Braun, Kusterdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/376,920

(22) PCT Filed: Jul. 10, 2007
(86) PCT No.: PCT/EP07/57045

§ 371 Date: Feb. 9, 2009

(30) Foreign Application Priority Data
Aug. 9, 2006 (DE) 102006037172.0

(51) Int. Cl. F16F 9/34

(52) U.S. Cl. 188/266.2

(57) ABSTRACT

The invention relates to a damper with a damper cylinder, in which a piston ram is guided via a piston rod. The flow rate of a damper fluid is adjustable for setting damper characteristic values. According to the invention, a control mechanism is arranged inside the damper cylinder, which has two independent control loops for a rebound stage period and a compression stage period. The control mechanism controls the flow rate of the damper fluid in a first flow direction with a first adjustment element during the compression stage period, and controls the flow rate of the damper fluid in a second flow direction with a second adjustment element during the rebound stage period.

The invention is based on a damper as generically defined by the preamble to claim 1.

From the prior art, dampers for vehicles are known whose characteristic shock absorber values can be adjusted via hydraulic proportional valves and adapted to different driving situations. These proportional valves, for instance with the aid of a control piston that is moved by an exciter coil, continuously control the fluid flow rate in the damper. The proportional valves are either flanged to the damper or integrated with the piston ram of the damper. An additional sensor, which is disposed on the wheel suspension, furnishes information about the state of retraction of the damper. As sensors, acceleration sensors or travel sensors with transmission rods can be used. Associated evaluation and control units are either disposed centrally in the vehicle or can be disposed noncentrally on the flanged-on proportional valve. The proportional valve may control the main fluid flow rate indirectly, or in other words, a small secondary flow is regulated directly by a small control piston and forms a differential pressure from the main valve. Because of this regulated differential pressure, the main fluid flow rate is established in the main valve. As a result, it is attained that with relatively slight adjusting forces, a relatively high pressure can be controlled. The reaction time of the damper is limited by the transient response of the proportional valve.

### DISCLOSURE OF THE INVENTION

The damper of the invention having the characteristics of independent claim 1 has the advantage over the prior art that inside the damper cylinder, control means are disposed which have two independent control loops for a rebound stage period and one compression stage period. During the rebound stage period, the control means control the flow rate of the damper fluid in a first flow direction with first adjustment means. During the compression stage period, the control means control the flow rate of the damper fluid in a second flow direction with second adjustment means. The damper of the invention, by means of the mechanical separation of the rebound stage period and the compression stage period, make unambiguous, independent control of the two damper forces possible. Moreover, the damper of the invention advantageously enables direct control of the fluid flow, which is effected practically without delays and/or transient states. The damper of the invention may be embodied as a dual-tube or single-tube damper, for example.

By the provisions and refinements recited in the dependent claims, advantageous improvements to the damper defined by the independent claim are possible.

It is especially advantageous that the possible adjustment variable of the first adjustment means can be adjusted for an ensuing compression stage period by associated first predetermining means during the rebound stage period preceding this compression stage period. The possible adjustment variable of the second adjustment means can be adjusted for the ensuing rebound stage period by associated second predetermining means during the compression stage period preceding this rebound stage period. The adjustment variables of the first and second adjustment means can for instance be implemented in the form of an adjusting stroke, an adjusting angle, as a variable spring constant, and so forth.

The adjustment variables for the first adjustment means and/or for the second adjustment means can for instance be ascertained by evaluating signals of an upper sensor unit and/or a lower sensor unit, which can for instance include pressure sensors, acceleration sensors, and/or travel sensors and associated electronic circuits. With the aid of the two sensor units, for instance, a force can be ascertained which acts directly on the damper and thus on the vehicle. This means that regulation to a variable that is perceived by a passenger, and particularly the driver, as shock is possible.

In a feature of the damper of the invention, the adjustment variable for one of the two adjustment means can be fixedly predetermined, and the required adjustment variable for the other of the two adjustment means can be ascertained during operation and variably adjusted by the associated predetermining means. This makes a simpler, less-expensive embodiment of the damper possible.

The predetermining means and/or the second predetermining means are each held in position in the loaded state by self-locking without counterforce. In addition, in the unloaded state the first predetermining means and/or the second predetermining means are each adjusted via corresponding drive units, embodied for instance as magnet coils or piezoelectric elements, and are triggered as a function of the signals of the upper and/or lower sensor unit. Because the adjustment of the predetermining means is decoupled from the actual work stroke of the adjustment means and is effected in the unloaded state, and because during the associated work stroke of the adjustment means the predetermining means are held by self-locking, slight adjusting forces are already sufficient to allow the use of magnet coils and/or piezoelectric elements as drive units. The corresponding work stroke of the adjustment means is represented by the flow direction in which the associated adjustment means performs the damping work. In addition, the damper of the invention enables a continuously variable and fast selection of throttle valves or characteristic damper curves, so that a varying selection of the damper characteristic, ranging from “very hard” to “very soft”, is possible, and these can advantageously be adjusted independently of one another for the compression stage period and for the rebound stage period.

The damper of the invention advantageously make it possible to use economical, relatively low-precision components as the control means. Moreover, it is possible for valve, wheel and/or vehicle body sensors and local electronic damper circuits to be fully integrated in a single unit.

In a further feature of the damper of the invention, the first and second adjustment means are each embodied as a throttle valve having an active region and a stop region. The adjustment variables of the adjustment means can each be predetermined by adjustable driving wedges and/or adjustment bushes, and the adjustment bushes each cooperate with corresponding stop regions, embodied as adjustment pegs, of the throttle valves. In addition, the first and second adjustment means can be combined with a rubber bearing to make an adjustment unit.

In a further feature of the damper of the invention, the first and second adjustment means, the first and second predetermining means, the associated electronic circuits, the drive units, and the upper and lower sensor units are embodied as a structural unit and preferably disposed in the piston ram.

Advantageous embodiments of the invention that are described below are shown in the drawings.

### BRIEF DESCRIPTION OF THE DRAWINGS

FIG. 1 shows a perspective view of a piston for a damper according to the invention.

FIG. 2 shows a top view on the piston for a damper of FIG. 1 according to the invention.

FIG. 3 shows an exploded view in perspective of the piston of FIG. 1.

FIG. 4 shows a schematic sectional view of a damper, for describing the control principle.

FIGS. 5A and 5B each show a schematic diagram of a characteristic force-time curve, for describing the control principle.

FIG. 6 shows a sectional view of a detail of a damper of the invention, in one exemplary embodiment.

FIG. 7 shows a cross section along the line VII-VII in FIG. 6.

FIG. 8 shows a sectional view of a detail of a damper of the invention, in an alternative exemplary embodiment.

FIG. 9A shows a perspective view of an adjustment means of the damper of FIG. 8 according to the invention.

FIGS. 9B and 9C each show a perspective view of an adjustment unit, each with two adjustment means of FIG. 9A.

FIGS. 10A through 10D each show a sectional view of a detail of the damper of FIG. 8 according to the invention, for describing the function of the damper of the invention.

### DESCRIPTION OF THE PREFERRED EMBODIMENTS

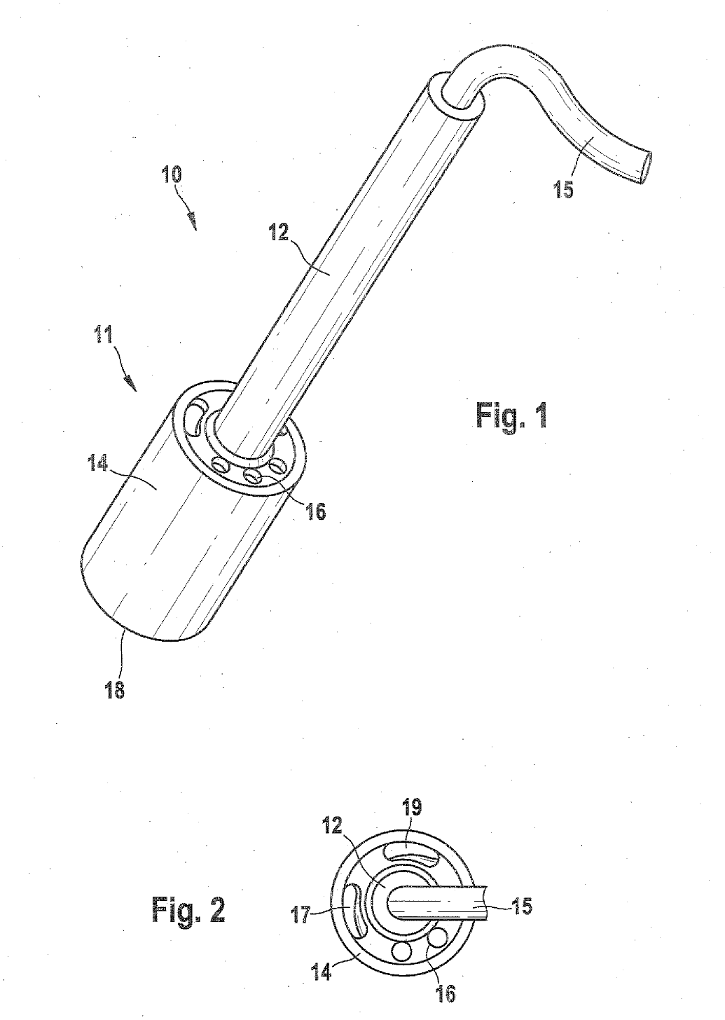

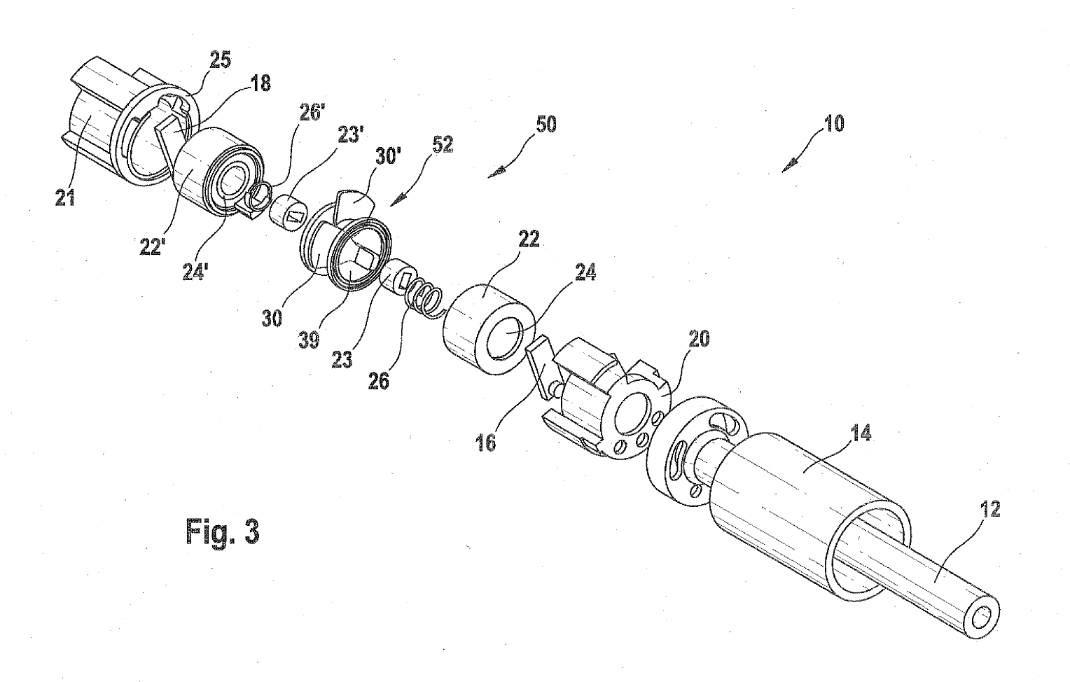

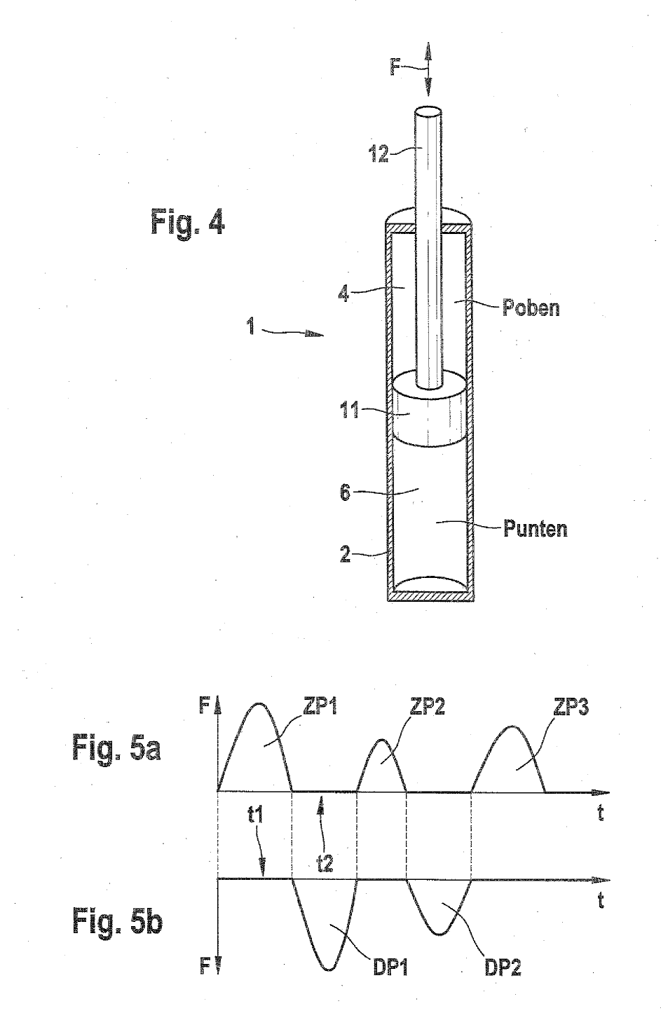

As seen in FIGS. 1-3, a piston 10 for a damper 1, preferably for a shock absorber of a vehicle, includes a piston rod 12 and a piston ram 11 secured to the piston rod 12. The piston ram 11 is embodied as a compact unit, which as its housing includes a ram tube 14, which is embodied as a thin-walled steel tube, for instance. Disposed in the ram tube 14 are an upper housing part 20 and a lower housing part 21, which are made from aluminum, for instance, and an upper sensor unit 16, a lower sensor unit 18, and control means 50. The two sensor units 16, 18 can for instance include pressure sensors, acceleration sensors and/or travel sensors, and one associated electronic circuit each. The control means in the exemplary embodiment shown include drive units 22, 22′, which are embodied for instance as magnet coils or piezoelectric elements, and adjustment bushes 23, 23′, friction sleeves 24, 24′, a stop ring 25, compression springs 26, 26′, an adjustment unit 52, and an evaluation and control unit, not shown, which evaluates signals from the two sensor units and accordingly triggers the control means 50 as a function of the evaluation of the adjustment of the flow rate of a damper fluid through a first control conduit 17 and a second control conduit 19. The evaluation and control unit, not shown, may likewise be disposed inside the piston ram 11 and can be embodied for instance as part of the electronic circuit of the upper and/or lower sensor unit 16, 18. Alternatively, the evaluation and control unit can be disposed outside the damper 1 in a control unit. The electrical power supply and the signal transmission for the sensor units 16, 18 and for the control and evaluation unit, not shown, is effected through a suitable bore in the piston rod 12 to the piston ram 11.

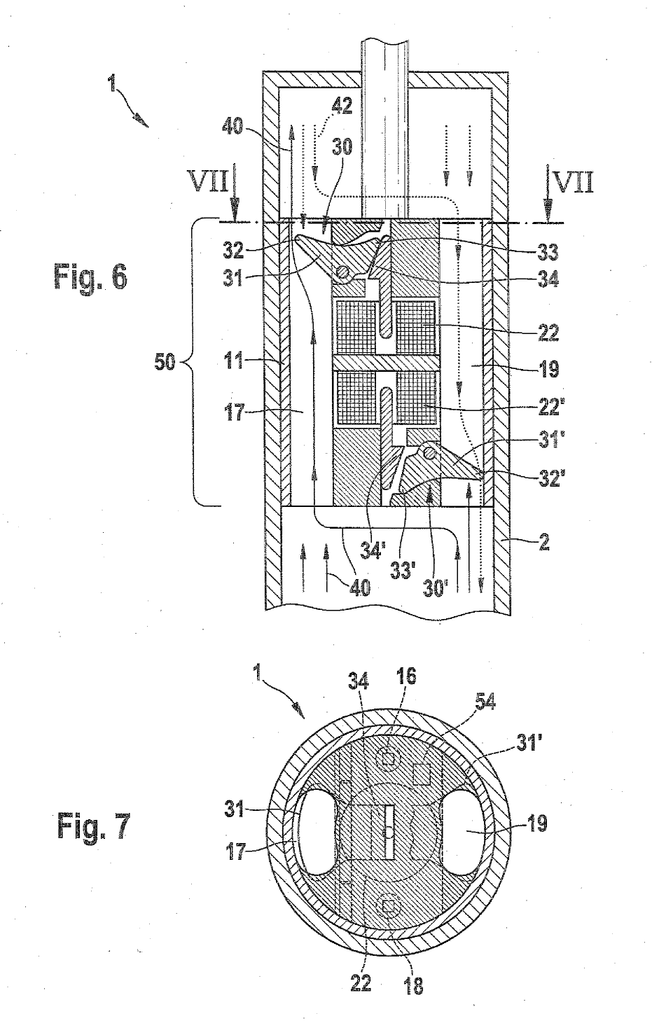

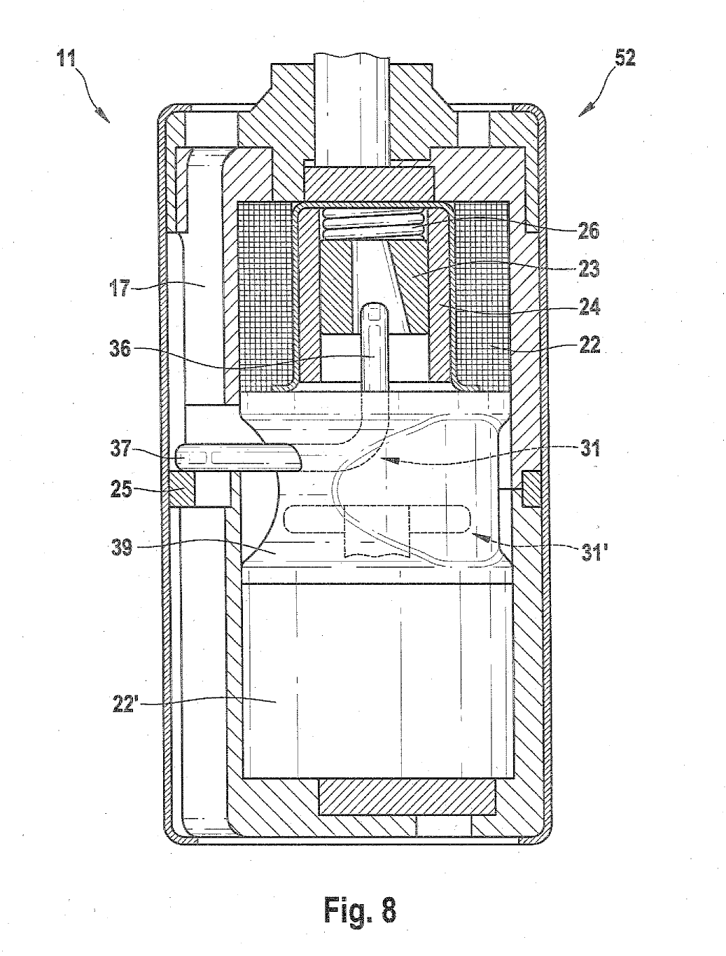

The mode of operation of the damper 1 of the invention will be described below in conjunction with FIGS. 4, 5A and 5B.

As seen from FIG. 4, the damper 1 includes a damper cylinder 2, in which the piston ram 11 is disposed movably via the piston rod 12. The piston ram 11 divides the damper cylinder 2 into an upper damper chamber 4 and a lower damper chamber 6. For instance, the upper pressure sensor unit 11 detects the pressure Poben in the upper damper chamber 4, and the lower sensor unit 18 detects the pressure Punten in the lower damper chamber 6. As a control variable for the control means 50, the force F that acts on the piston 10 of the damper 1 is used. With the aid of the two sensor units 16, 18, the force F that acts on the damper 1 and thus on the vehicle is ascertained directly. This means that regulation can be done to a variable that is perceived by a passenger and especially by the driver as shock. The operative force F can be ascertained directly from the two pressures, Poben and Punters, that are detected by the sensor units 16, 18 at the upper and lower sides of the piston ram 11.

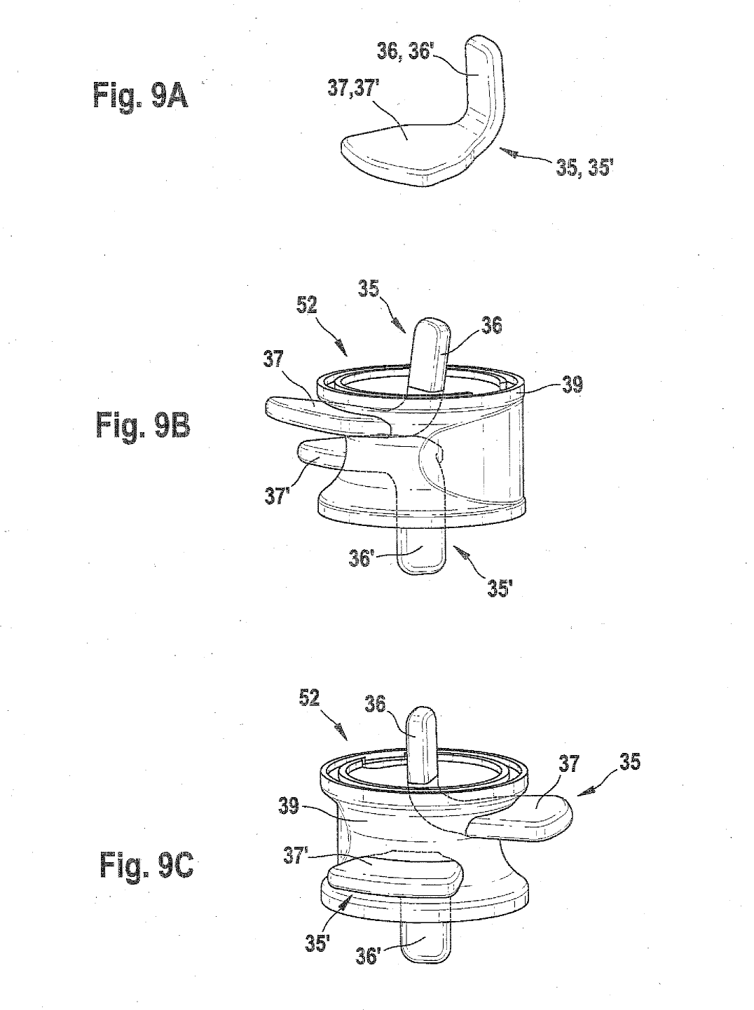

The control means 50 that are located inside the damper cylinder 2 in the piston ram 11 include two independent control loops for a rebound stage period and a compression stage period. For controlling the flow rate of the damper fluid through the first control conduit 17 in a first flow direction 40 during the compression stage period, the control means 50 have first adjustment means 30, which will be described in detail hereinafter in conjunction with FIGS. 6 through 9C. For regulating the flow rate of the damper fluid through the second control conduit 19 in a second flow direction 42 during the rebound stage period, the control means 50 have second adjustment means 30′, which will be described in detail hereinafter in conjunction with FIGS. 6 through 9C.

FIG. 5A shows a force-time graph for rebound stage periods ZP1, ZP2, ZP3, and FIG. 5B shows a force-time graph for compression stage periods DP1, DP2. As seen in FIGS. 5A and 5B, the possible adjustment variable of the first adjustment means 30 is adjusted for a first compression stage period DP1 by associated first predetermining means during the time period t1, which corresponds to the first rebound stage period ZP1 that precedes this first compression stage period DP1. The possible adjustment variable of the first adjustment means 30 for a second compression stage period DP2 is adjusted by the associated first predetermining means during the second rebound stage period ZP2 that precedes the second compression stage period DP2, and so forth. The possible adjustment variable of the second adjustment means 30′ for a second rebound stage period ZP1 is adjusted by associated second predetermining means during the time period t2, which corresponds to the first compression stage period DP1 preceding this second rebound stage period ZP2. The possible adjustment variable of the second adjustment means 30′ for a third rebound stage period ZP3 is adjusted by associated predetermining means during the second compression stage period DP2 preceding this third rebound stage period ZP3, and so forth. Thus during the first rebound stage period ZP1, the flow rate of the damper fluid through the second control conduit 17 in the second flow direction 52 is adjusted via the second adjustment means 30′. Simultaneously, during the first rebound stage period ZP1, the adjustment variable of the first adjustment means 30 for the first compression stage period DP1 is adjusted accordingly via the predetermining means, and the required adjustment variable of the second adjustment means 30′ for the second rebound stage period ZP2 is ascertained. Next, during the first compression stage period DP1, the flow rate of the damper fluid through the first control conduit 17 in the first flow direction 40 is adjusted via the first adjustment means 30. Simultaneously, during the first compression stage period DP1, the adjustment variable of the second adjustment means 30′ for the second compression stage period DP2 is adjusted accordingly via the predetermining means, and the required adjustment variable of the first adjustment means 30 for the second compression stage period DP2 is ascertained. Next, during the second rebound stage period ZP2, the flow rate of the damper fluid through the second control conduit 19 in the second flow direction 42 is adjusted via the second adjustment means 30′, and so forth.

The required adjustment variables for the first adjustment means 30 and/or for the second adjustment means 30′ are ascertained by evaluating signals of the upper sensor unit 16 and/or of the lower sensor unit 18. By the described mechanical separation of the rebound stage period and the compression stage period, unambiguous and independent control of the flow rate of the damper fluid through the first control conduit 17 and the second control conduit 19 can be attained. The adjustment of the predetermining means for adjusting the associated adjustment variable for the rebound stage period and compression stage period is advantageously always done during the unloaded state of the respective predetermining means.

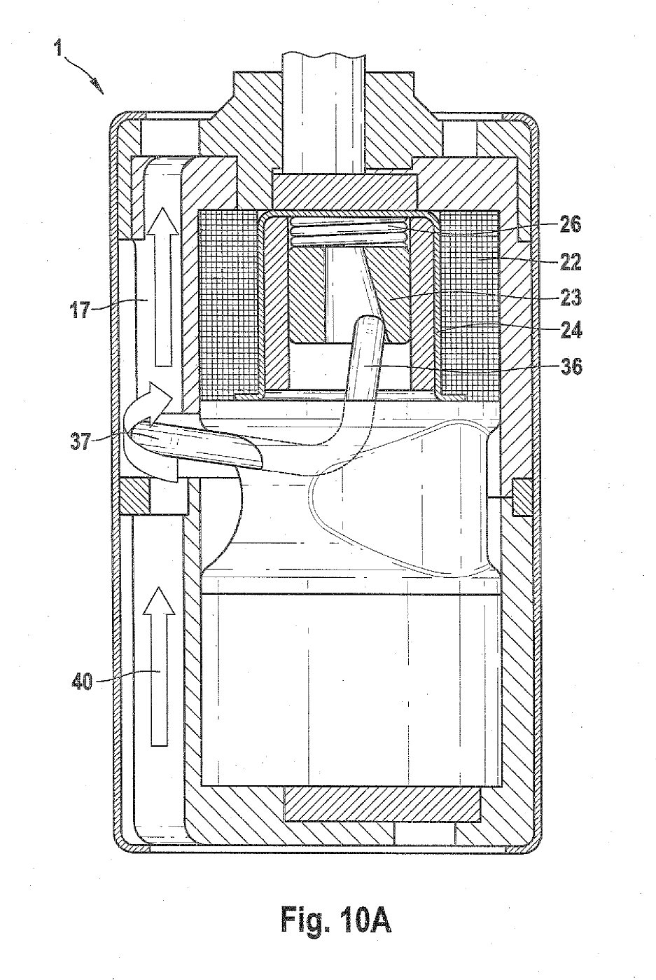

One exemplary embodiment of a damper 1 of the invention is described below in conjunction with FIGS. 6 and 7. As seen in FIGS. 6 and 7, the damper 1 of the invention includes the cd 2, in which a piston ram 11 is movably disposed. Control means 50 are disposed in the piston ram 11, and their first and second adjustment means 30, 30′ are embodied as throttle valves 31, 31′, respectively, which have a respective active region 32, 32 and a stop region 33, 33′. The work strokes of the throttle valves 31, 31′ are predetermined respectively by the associated first and second predetermining means, which are embodied as adjustable driving wedges 34, 34′ and which act to limit the maximum possible flow cross section in the respective control conduit 17, 19 to the stop region 33, 33′ of the associated throttle valve 31, 31′.

The first rotatably supported throttle valve 31 varies the flow cross section of the damper fluid in the first control conduit 17 in the pressure direction during the compression stage period and thus predetermines the damping force. the throttle valve 31 is limited in its opening angle by the first driving wedge 31, located to the rear. The first driving wedge 34 is designed such that in the loaded state, during the compression stage period, it is kept in position by self-locking, without counterforce. If during the rebound stage period the fluid flows in an opposite direction 42, then the first throttle valve 31 closes, because of its disposition and its geometry. Then its rear side, that is, its stop region 33, no longer rests on the first driving wedge 34. In this unloaded state, the first driving wedge 34 can be moved to a different desired position by means of a slight adjusting force. This is done with the aid of a first drive unit 22, which is embodied as a magnet coil and into which a pistonlike end of the first driving wedge 34 protrudes. Analogously, via the second throttle valve 3F and the second driving wedge 34′ and a second drive unit 22′ embodied as a magnet coil, the damping force in the tension direction 42 can be varied during the rebound stage period. Via the sensor units 15, 18 disposed on the top and bottom sides, respectively, of the piston ram 11, the actual damping force at the time is ascertained. The pressure value or damping force ascertained is compared with a desired pressure value or damping force. Next, via suitable triggering of the applicable magnet coil 22, 22′, the position of the corresponding driving wedge 34, 34′ is changed, as soon as the affected driving wedge 34, 34′, on the next change of direction, is no longer loaded. For the ensuing period, the associated driving wedge 34, 34′ is now in the new position, and it predetermines the desired new damping characteristics. As also seen from FIG. 5, the drive units 22, 22′ for the predetermining means embodied as driving wedges 34, 34′ are disposed between the two adjustment means 30, 30′. Via an acceleration sensor 54 disposed on the piston ram 11, the vehicle body frequency can be ascertained.

Because the adjustment of the predetermining means 34, 34′ is decoupled from the actual work stroke of the adjustment means 30, 30′ and is switched in the unloaded state of the predetermining means 34, 34′, and because the predetermining means 34, 34′ are held by self-locking during the work stroke of the adjustment means 30, 30′, even slight adjusting forces suffice for the adjustment, so that magnet coils and/or piezoelectric elements can be used as drive units 22, 22′.

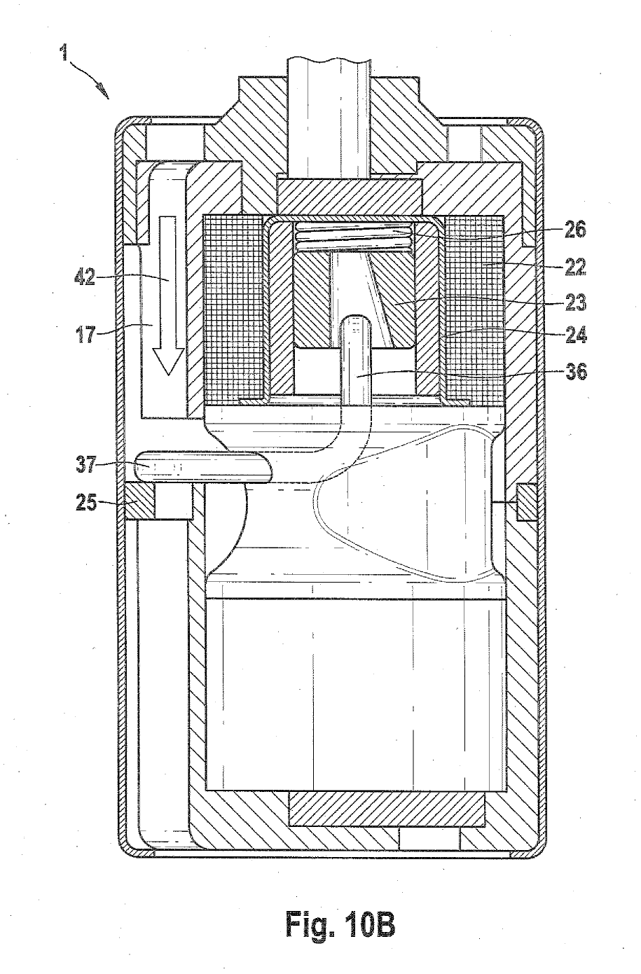

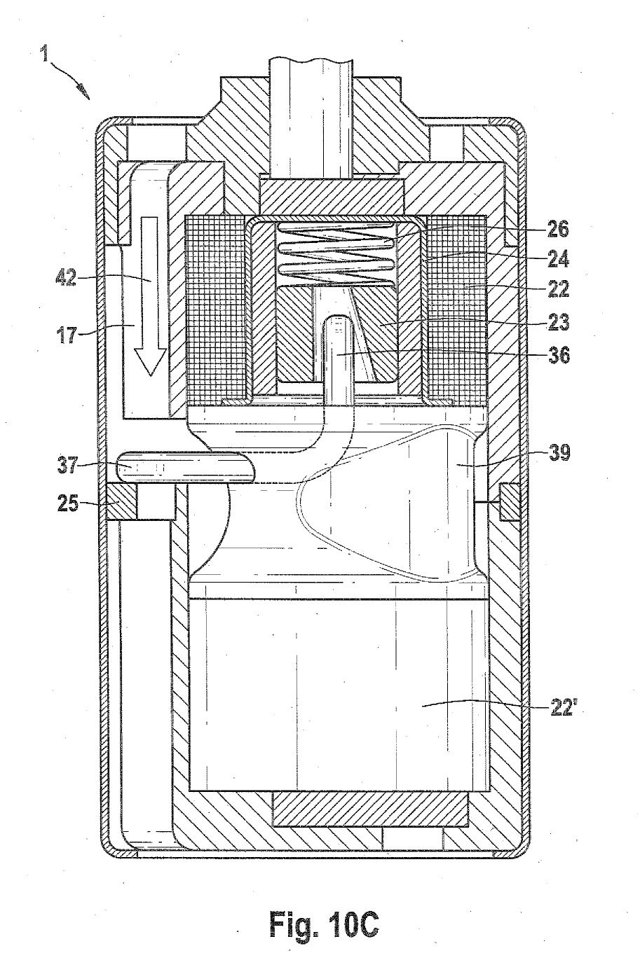

Below, in conjunction with FIGS. 8 through 9C, an alternative exemplary embodiment of a damper 1 of the invention will be described. As seen in FIGS. 8 through 9C, the first and second adjustment means 30, 30′ of the control means 50 can alternatively be combined into one adjustment unit 52. The adjustment unit 52 includes first adjustment means 30, which are embodied as a throttle valve 35 and whose stop region is embodied as an djustment peg 36 and whose active region is embodied as a valve flap 37; second adjustment means 30′, which are embodied as a throttle valve 35′ and whose stop region is embodied as an adjustment peg 36′ and whose active region is embodied as a valve flap 37; and a rubber bearing 39. Unlike the first exemplary embodiment, the adjustment unit 52 is disposed between the two drive units 22 and 22′; a first drive unit 22 surrounds a first adjustment bush 23 cooperating with the adjustment peg 36 of the first throttle valve 35, and a second drive unit 22′ surrounds a second adjustment bush 23′ cooperating with the adjustment peg 36′ of the second throttle valve 35′.

As seen from FIG. 8, to predetermine the adjustment variable for the first valve flap 37, the active region, embodied as an adjustment peg 36, of the first adjustment means 30 cooperates with an internal contour of the associated adjustment bush 23. The internal contour of the adjustment bush 23 may be embodied as a wedge-shaped or conical recess, for example. The adjustment bush 23 is surrounded by the drive unit 22, which is embodied for instance as a magnet coil and is supplied suitably with current for adjusting the adjustment bush 23. A compression spring 26 displaces the adjustment bush 23 in the direction of the adjustment peg 36. As a result, upon a voltage drop at the magnet coil 22, a hard characteristic damper curve is established, so that in the event of failure of the drive unit 22, a fail-safe mode of operation is advantageously attained. The adjustment bush 23 is braced on a friction sleeve 24, which may for instance have a friction lining embodied as a rubber lining. The advantageous result is an elastic stop with an overpressure function. Moreover, a larger wedge angle is possible by means of a more-favorable pairing of materials. The mode of operation of the second adjustment means 30′ embodied as a throttle valve 35′ is equivalent to the mode of operation of the first adjustment means 30, so a repetition of its description is therefore dispensed with.

As seen from FIG. 9A, the throttle valves 35, 35′ can each be embodied as a bent metal part, which includes an adjustment peg 36, 36′ as its stop region and a valve flap 37, 37′ as its active region.

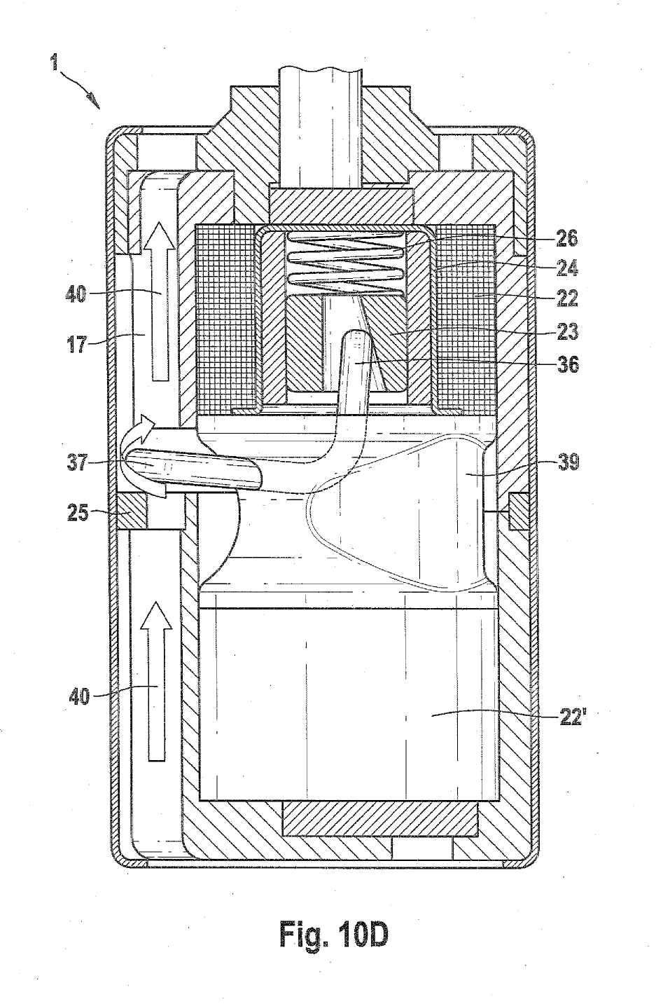

As seen from FIGS. 9B and 9C, the adjustment unit 52 may be embodied as a rubber-and-metal part, which in a rubber bearing 39 combines the first throttle valve 35, embodied as a valve flap 37 having an adjustment peg 36, with the second throttle valve 35′, embodied as a valve flap 37′ having an adjustment peg 36′. As described hereinafter in conjunction with FIGS. 10A through 10D, the adjustment variables of the first and second adjustment means 30, 30′, each supported elastically in the rubber bearing 39, can each be predetermined by the first and second predetermining means, respectively. The predetermining means are each embodied as adjustable adjustment bushes 23, 23° that cooperate with the corresponding adjustment pegs 36, 36′.

In conjunction with FIGS. 10A through 10D, the mode of operation of the adjustment unit 52 of the damper of the invention will now be described. As seen from FIG. 10A, during the compression stage period, a damper fluid flows in the first control conduit 17 in the first flow direction 40, which is also called the pressure direction. The damper fluid flowing through opens the rubber-supported valve flap 37 of the first throttle valve 35. The adjustment peg 36 of the first throttle valve 35, as fluid flows through it, presses against the internal contour of the adjustment bush 23, which is made from steel, for instance. Depending on the position of the adjustment bush 23 inside the friction sleeve 24, the possible opening angle and thus the work stroke of the valve flap 37 can be adjusted.

As seen from FIG. 10B, during the rebound stage period, the fluid in the first control conduit 17 flows in the second flow direction 42, also called the tension direction. Because of the fluid flow in the second flow direction 42, the first valve flap 37 is closed; that is, the first valve flap 37 rests on the stop ring 25. The actual fluid flow in the second flow direction takes place in the second control conduit 19, not shown, which analogously to the above description is controlled by the rubber-supported second throttle valve 35′. The adjustment peg 36 of the closed first throttle valve 35 no longer rests on the internal contour of the adjustment bush 23. In this unloaded state, the adjustment bush 23 can be moved to a new position by slight forces, exerted by the first drive unit 22 embodied as a magnet coil. FIG. 10C shows the adjustment bush 23 in its new position, after the adjustment operation. As seen from FIG. 10C, the adjustment bush 23 has been put into the maximal lower position.

FIG. 10D shows the effects of the new position of the adjustment bush 23 on the fluid flow through the first control conduit 17 in the pressure direction 40 during the ensuing compression stage period. The first throttle valve 35 now has the hardest characteristic damper curve, which is represented by a small opening angle and thus by a small adjustment variable of the valve flap 37.

In the second control conduit 19, not shown, the control of the fluid flow with the second throttle valve 35′ in the second flow direction 42 is effected analogously to the description of the control of the fluid flow in the first flow direction 40 in the first control conduit 17 by the first throttle valve 35.

In an alternative embodiment, not shown, of the damper of the invention, the adjustment variable for one of the two adjustment means 30, 30′ may be fixedly predetermined, and the requisite adjustment variable of the other of the two adjustment means 30, 30′ can be ascertained during operation and adjusted variably by the associated predetermining means. For instance, the flow of damper fluid in the first control conduit 17 can be controlled by predetermining a constant adjustment variable for the associated first adjusting element 30. The adjusting element 30 may for instance be embodied as a conventional leaf spring with an active region and an unchanging spring constant; the spring constant represents the constant adjustment variable. As a result, the first drive unit 22 and the predetermining means can advantageously be dispensed with. The flow of damper fluid in the second control conduit 19, however, is embodied as variable, and as noted above, it can be varied via the second adjusting element 30′ by means of the adjustable second driving wedge 34′ or the adjustable second adjustment bush 23′. Analogously, the damper fluid flow in the second control conduit 19 can be controlled by predetermining a constant adjustment variable for the associated second adjusting element 30′.

The embodiments of the damper of the invention advantageously make it possible for the most optimal adjustment of the characteristic damper values to be attained at all times in different driving situations. In contrast to a conventional hydraulic proportional valve, the flap valves according to the invention enable direct control of the main fluid flow, practically without delays and without transient states, and the control can advantageously be done, using only slight adjusting forces, by decoupling the adjustment operation from the actual work stroke. Because of the very compact embodiment that is possible, the damper of the invention is also suitable for damping the passenger compartments of utility vehicles, for damping vehicle seats, semitrailers, and so forth. The damper of the invention is furthermore suitable for applications outside the automotive field, such as in mechanical engineering, where a controllable damper of compact design is necessary.

1-10. (canceled)

11. A damper comprising:
a damper cylinder in which a piston ram is guided via a piston rod, a flow rate of a damper fluid being controllable for adjusting characteristic damper values;
control means 40 disposed inside the damper cylinder, which have two independent control loops for a rebound stage period and one compression stage period;
first adjustment means of the control means for controlling the flow rate of the damper fluid in a first flow direction during the compression stage period; second adjustment means of the control means for controlling the flow rate of the damper fluid in a second flow direction during the rebound stage period.

12. The damper as defined by claim 11, wherein a possible adjustment variable of the first adjustment means is adjustable for an ensuing compression stage period by associated first predetermining means during the rebound stage period preceding this compression stage period.

13. The damper as defined by claim 11, wherein a possible adjustment variable of the second adjustment means is adjustable for the ensuing rebound stage period by associated second predetermining means during the compression stage period preceding this rebound stage period.

14. The damper as defined by claim 12, wherein a possible adjustment variable of the second adjustment means is adjustable for the ensuing rebound stage period by associated second predetermining means during the compression stage period preceding this rebound stage period.

15. The damper as defined by claim 11, wherein the adjustment variables for the first adjustment means and/or for the second adjustment means are ascertainable by evaluating signals of an upper sensor unit and/or a lower sensor unit, which are preferably embodied as pressure sensor units.

16. The damper as defined by claim 12, wherein the adjustment variables for the first adjustment means and/or for the second adjustment means are ascertainable by evaluating signals of an upper sensor unit and/or a lower sensor unit, which are preferably embodied as pressure sensor units.

17. The damper as defined by claim 13, wherein the adjustment variables for the first adjustment means and/or for the second adjustment means are ascertainable by evaluating signals of an upper sensor unit and/or a lower sensor unit, which are preferably embodied as pressure sensor units.

18. The damper as defined by claim 11, wherein the adjustment variable for one of the two adjustment means is fixedly predetermined, and the required adjustment variable for the other of the two adjustment means is ascertainable during operation and is variably adjustable by the associated predetermining means.

19. The damper as defined by claim 12, wherein the adjustment variable for one of the two adjustment means is fixedly predetermined, and the required adjustment variable for the other of the two adjustment means is ascertainable during operation and is variably adjustable by the associated predetermining means.

20. The damper as defined by claim 13, wherein the adjustment variable for one of the two adjustment means is fixedly predetermined, and the required adjustment variable for the other of the two adjustment means is ascertainable during operation and is variably adjustable by the associated predetermining means.

21. The damper as defined by claim 15, wherein the adjustment variable for one of the two adjustment means is fixedly predetermined, and the required adjustment variable for the other of the two adjustment means is ascertainable during operation and is variably adjustable by the associated predetermining means.

22. The damper as defined by claim 12, wherein the first predetermining means and/or the second predetermining means can each be held in position in the loaded state by self-locking without counterforce.

23. The damper as defined by claim 13, wherein the first predetermining means and/or the second predetermining means can each be held in position in the loaded state by self-locking without counterforce.

24. The damper as defined by claim 15, wherein the first predetermining means and/or the second predetermining means can each be held in position in the loaded state by self-locking without counterforce.

25. The damper as defined by claim 12, wherein the first predetermining means and/or the second predetermining means are each adjustable in the unloaded state via respective drive units that are triggerable as a function of the signals of the upper and/or lower sensor unit, which are preferably embodied as pressure sensor units.

26. The damper as defined by claim 13, wherein the first predetermining means and/or the second predetermining means are each adjustable in the unloaded state via respective drive units that are triggerable as a function of the signals of the upper and/or lower sensor unit, which are preferably embodied as pressure sensor units.

27. The damper as defined by claim 11, wherein the first and second adjustment means are each embodied as a throttle valve having an active region and a stop region, whose adjustment variables are each predeterminable by adjustable driving wedges and/or adjustment bushes, and the adjustment bushes each cooperate with corresponding stop regions, embodied as adjustment pegs, of the throttle valves.

28. The damper as defined by claim 12, wherein the first and second adjustment means are each embodied as a throttle valve having an active region and a stop region, whose adjustment variables are each predeterminable by adjustable driving wedges and/or adjustment bushes, and the adjustment bushes each cooperate with corresponding stop regions, embodied as adjustment pegs, of the throttle valves.

29. The damper as defined by claim 11, wherein the first and second adjustment means are combinable with a rubber bearing to make an adjustment unit.

30. The damper as defined by claim 11, wherein the first and second adjustment means, the first and second predetermining means, electronic circuits, the drive units, and the upper and lower sensor units are embodied as a structural unit and preferably disposed in the piston ram.
